(19) United States
(12) Patent Application Publication
(10) Pub. No.: US 2015/0093579 A1
(43) Pub. Date: Apr. 2, 2015

(54) METHOD OF PREPARATION OF ALANE-ETHERATE AND ALANE

(71) Applicant: Intelligent Energy Inc., San Jose, CA (US)

(72) Inventor: Allison M. Fisher, Valley City, OH (US)

(73) Assignee: Intelligent Energy Inc.

(21) Appl. No.: 14/558,569

(22) Filed: Dec. 2, 2014

Related U.S. Application Data
(63) Continuation of application No. PCT/US2013/043980, filed on Jun. 10, 2013.
(60) Provisional application No. 61/655,511, filed on Jun. 5, 2012.
(60) Provisional application No. 61/732,962, filed on Dec. 4, 2012.

(51) Int. Cl. C01B 6/06; C01B 6/34

(52) U.S. Cl. CPC C01B 6/06; C01B 6/34
USPC 428/402; 423/645

(57) ABSTRACT

The invention to preparing alane-etherate and alane by producing an alane-etherate complex using an acid including one or a combination of hydrochloric acid and methanesulfonic acid and a metal tetrahydroaluminate in a solvent including an ether such as diethyl ether. The alane-etherate can be desolvated using a spray desolvation process such as electrospraying.

### TECHNICAL FIELD

This invention relates to methods of preparing alane-etherate and alane by producing alane diethyl etherate using acids such as sulfuric acid, hydrochloric acid, and methanesulfonic acid with a metal tetrahydroaluminate in diethyl ether.

### BACKGROUND OF THE INVENTION

A key limiting factor in the widespread adoption of proton exchange membrane fuel cell (PEMFC) based power systems is hydrogen fuel storage. The development of a viable hydrogen storage solution will have a profound impact on how consumers will power portable devices, since batteries simply cannot match demands for runtime, energy density and reliability.

Because hydrogen has poor energy content per volume (0.01 kJ/L at STP and 8.4 MJ/L for liquid hydrogen vs. 32 MJ/L for petroleum), physical transport and storage as a gas or liquid is impractical. Additionally, the compression process to achieve the pressures necessary to reach a high density is energy-intensive and doesn't solve the hazard issue. Also, the densities of compressed H₂ or liquefied H₂ are still below those required to reach practical fuel storage goals.

Physical means to store hydrogen include sorbents such as carbon nanotubes and foams, zeolites, metal-organic frameworks; and intermetallics such as titanium-manganese alloy 5800, complex hydrides such as metal alanates, amides, and borohydrides, and chemical hydrides such as sodium borohydride/water and ammonia borane (AB). Despite intensive and elegant work on sorbents and complex hydrides, practical systems that can store and release ≧6 wt % hydrogen at moderate temperatures are still far from realization.

Alane is an attractive candidate for solid hydrogen storage and release because it has a density of 1.48 g/cm³ and releases up to 10 weight percent hydrogen and aluminum in a single step upon heating to ≦200° C. Alane's formula is sometimes represented with the formula (AlH₃)ₙ because it is a polymeric network solid. Alane is formed as numerous polymorphs: the alpha (α), alpha prime (α′), beta (β), delta (δ), epsilon (ε), zeta (ζ), or gamma (γ) polymorphs. Each of the polymorphs has different physical properties and varying stability. The most thermally stable polymorph is α-alane, featuring aluminum atoms surrounded by six hydrogen atoms that bridge to six other aluminum atoms. The Al—H distances are all equivalent and the Al—H—Al angle is approximately 141°. While α-alane's crystals have a cubic or hexagonal morphology, α′-alane forms needlelike crystals and γ-alane forms a bundle of fused needles. Typically, the lightweight, unstable γ-alane is produced first, converting under certain conditions to the more stable rhombohedral β-alane polymorph first, then to α-alane. When trace amounts of water are present during crystallization the δ-alane and ε-alane can be formed. The ζ-alane polymorph is prepared by crystallization from di-n-propyl ether. The α′, δ, ε, and ζ polymorphs do not convert to α-alane upon heating and are less thermally stable than α-alane.

Crystalline alane has many uses including: hydrogen storage, inorganic and organic synthesis, as an ingredient in propellants and pyrotechnics, as a polymerization catalyst, and as a precursor to aluminum films and coatings. Consequently there has been considerable research carried out on the preparation of alane, since the first report of its preparation in 1942 (Stecher and Wiberg, Ber. 1942, 75, 2003). Finholt, Bond, and Schlesinger reported an improved method of synthesis of alane-diethyl etherate in 1947 which has formed the foundation for most of the reported methods for the synthesis of non-solvated crystalline alane (J. Am. Chem. Soc., 1947, 69, 1199). The reaction is shown below, and the amount of ether complexed to the alane product depended on the length and temperature of the drying step of the reaction:

3LiAlH₄+AlCl₃→4AlH₃+3LiCl.

Reports describing the preparation and stabilization of non-solvated crystalline alane began to appear in the patent literature in 1974 (Scruggs, U.S. Pat. No. 3,801,657, Roberts et al. U.S. Pat. No. 3,803,082, King, U.S. Pat. No. 3,810,974, Matzek et al. U.S. Pat. No. 3,819,819, Daniels et al. U.S. Pat. No. 3,819,335, Roberts, U.S. Pat. No. 3,821,044, Brower et al. U.S. Pat. No. 3,823,226, Schmidt et al. U.S. Pat. No. 3,840,654, and Self et al. U.S. Pat. No. 3,844,854). Removal of the residual diethyl ether (“desolvation”) was effected by using higher than stoichiometric ratios of complex aluminum hydride to aluminum chloride, as well as inclusion lithium borohydride as a “seeding” or “crystallization” agent. Several patents describe the use of sodium aluminum hydride instead of lithium aluminum hydride (Ashby et al. U.S. Pat. No. 3,829,390, and Kraus et al. U.S. Pat. No. 3,857,930). As disclosed in these patents and Brower et al. (“Brower”), “Preparation and Properties of Aluminum Hydride,” J. Am. Chem. Soc., 1976, 98, 2450, alane is usually synthesized by reacting aluminum trichloride (AlCl₃) and metal aluminum hydride (MAlH₄) in diethyl ether or diethyl ether-hydrocarbon solvent mixtures. The aluminum trichloride was dissolved in diethyl ether at −10° C. A minimum of three mole equivalents of MAlH₄ was added to the aluminum trichloride solution to produce a solvated alane-ether complex and a precipitate of metal chloride (MCl, e.g. LiCl or NaCl). In order to desolvate the alane-ether complex, 0.5 to 4.0 mole equivalents of a borohydride salt, such as lithium borohydride or sodium borohydride, was mixed with the solution including the alane-ether complex. The mixture was filtered and the filtrate was diluted with toluene or benzene to provide an ether to toluene or benzene ratio of 15:85. The mixture was heated to 85° C. to 95° C. to desolvate the alane-ether complex and the diethyl ether was subsequently removed by distillation. The precipitated alane was recovered by aqueous acid quenching, filtration, and washing. Brower also discloses that the reaction is conducted in the absence of water, oxygen, and other reactive species because if water is present, the δ and ε polymorphs are undesirably formed.

The methods reported for stabilization of the reactive alane product during this time included in situ or subsequent treatment of alane with an alkyl or aryl silicol, coating the alane surface with an organic compound containing at least one phenyl group or a condensed ring structure, and washing the alane product (often with some amount of magnesium included in the preparation step) with an aqueous solution buffered at from about pH 6 to 8.

However, the large volumes of solvent required as well as the excess aluminohydride and borohydride salts used to desolvate the alane-ether complex make these syntheses of α-alane expensive. The borohydride salts also generate byproducts that require disposal. Furthermore, the alane produced by the method of Brower is typically contaminated with undesirable polymorphs and is prone to decomposition during desolvation.

Current methods for the preparation of alane are expensive because of, among other things, the high cost of the large amounts of solvent needed to prepare the stable α-alane crystalline phase. It would be desirable to reproducibly produce a high yield of α-alane using a low-cost method.

An object of the present invention is to provide an improved low-cost method for the preparation of α-alane suitable for use as a solid hydrogen storage and release material.

### SUMMARY OF THE INVENTION

According to one aspect of the invention, an alane-etherate complex is produced by a method including reacting one or more acids, selected from hydrochloric acid and methanesulfonic acid, with one or more metal tetrahydroaluminates in a solvent including an ether. Embodiments can include one or more of the following:
the one or more acids consist of one or a combination of hydrochloric acid and methane sulfonic acid; the one or more acids can consist of hydrochloric acid; the one or more acids can consist of methanesulfonic acid;
the one or more metal tetrahydroaluminates include LiAlH₄; the one or more metal tetrahydroaluminates can consist of LiAlH₄;
the one or more metal tetrahydroaluminates include NaAlH₄; the one or more metal tetrahydroaluminates can consist of NaAlH₄; and
the solvent comprises diethyl ether; the solvent can consist of diethyl ether.

According to another aspect of the invention, α-alane is produced by a method including forming an alane-etherate complex by the method described above, desolvating the alane-etherate complex; and heating at a temperature of from greater than 60° C. to less than 120° C. to produce the α-alane. Embodiments can include one or more of the following:
desolvating the alane-etherate complex includes spray desolvation; the spray desolvation can include electrospinning; the spray desolvation can include electrospraying; the electrospraying can include heating at a temperature from greater than 60° C. to less than 120° C.; the temperature can be at least 65° C.; the temperature can be no greater than 100° C.
desolvating the alane-ethereate complex includes collecting electrosprayed material and annealing the collected electrosprayed material at a temperature of from 65° C. to 100° C. to form the α-alane.

These and other advantages of the invention will be further understood and appreciated by those skilled in the art by reference to the following written specification and claims.

### BRIEF DESCRIPTION OF THE DRAWINGS

In the drawings:

FIG. 1 shows an electrospraying assembly schematic;

FIG. 2 shows TGA results for the electrospraying of 1 weight percent alane-etherate solutions compared to a conventional vacuum drying method; and

FIG. 3 shows SEM images comparing the alane produced by electrospraying to conventionally-dried alane-etherate.

### DETAILED DESCRIPTION OF THE PREFERRED EMBODIMENTS

The embodiments of the present inventions described below are not intended to be exhaustive or to limit the invention to the precise forms disclosed in the following detailed description. Rather the embodiments are chosen and described so that others skilled in the art may appreciate and understand the principles and practices of the present inventions.

All publications and patents mentioned herein are incorporated herein by reference in their respective entireties for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventor is not entitled to antedate such disclosure by virtue of prior invention.

For purposes of description herein, the terms “upper,” “lower,” “right,” “left,” “rear,” “front,” “vertical,” “horizontal,” and derivatives thereof shall relate to the invention as oriented in the figures. However, it is to be understood that the invention may assume various alternative orientations and step sequences, except where expressly specified to the contrary. It is also to be understood that the specific parts, devices and processes illustrated and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In one aspect, the invention relates to hydrogen storage compositions containing alane. As used herein, “alane” refers to AlH₃, and includes combinations of the different alane polymorphs. In contrast, when referring to a specific polymorph of alane, the designation of the specific polymorph is used, such as “α-alane.”

The alane used in the invention can have any acceptable purity level. Preferably for fuel cell applications, the alane is free of organic contaminants. For example, the alane is preferably non-adducted and non-solvated by organic species. The hydrogen storage compositions of the present invention can also have a number of applications other than fuel cells. For some of these other applications, e.g., as catalysts, chemical reactants, propellant, and so on, the alane may contain organic species.

The alane can be completely composed (i.e., 100 percent by weight) of any of the alane compositions described above. Alternatively, the alane can include another compound or material which is not an alane polymorph.

The alane can also be in any suitable physical form. For example, the alane can be in particulate form, e.g., powder, crystalline, polycrystalline, microcrystalline, pelletized, granular, and so on. The size of the alane particles is not particularly critical to the operability of the present invention. For example, any one or more dimensions of the particles can be one centimeter or less, 50 millimeters or less, 40 millimeters or less, 30 millimeters or less, 20 millimeters or less, 10 millimeters or less, 1 millimeter or less, 500 microns or less, 250 microns or less, 100 microns or less, 50 microns or less, 20 microns or less, 10 microns or less, 1 micron or less, 500 nanometers or less, 250 nanometers or less, 100 nanometers or less, 50 nanometers or less, and so on. In preferred embodiments, the alane is composed of particles of 1 to 250 microns or 50 to 100 microns. The particles of alane can also have any of several morphologies. For example, the particles can be approximately spherical, oblong, rectangular, square planar, trigonal bipyramidal, cylindrical, octahedral, cubooctahedral, icosahedral, rhombohedral, rod-shaped, cuboidal, pyramidal, amorphous, and so on. Alternatively, the alane can be in non-particulate form, e.g., in block form, in sheet form, as a coating, a film, an interconnected or interwoven network, or a combination thereof.

The alane composition is capable of efficiently and controllably producing hydrogen for a sustained period of time. For example, for fuel cell applications, it would be particularly preferred for the alane composition to be capable of releasing adequate levels of hydrogen at a steady rate for a period of several hours or days. For applications where hydrogen demand varies with time, it is possible and preferable to vary the hydrogen desorption rate by varying the temperature.

In a preferred embodiment, the alane is in a modified form. The modified form can be, for example, a purified form in which the alane was prepared and maintained (stored) in a reduced oxygen, oxygen-free, low humidity, and/or zero humidity environment. Such purified forms of alane also contain low levels of impurities. The modified form can also be, for example, a specific crystalline phase or mixture of specific phases of alane. For example, the alane can be partially, or wholly, enriched in one or more of the crystalline phase. The crystalline phases can be present in amounts of, for example, one, five, ten, twenty, fifty, sixty, seventy, eighty, ninety, ninety-five, and higher weight percents, of the total amount of alane.

In a particularly preferred embodiment, the modified alane is a purified alane composed completely of one or more crystalline phases. In a preferred embodiment, the purified crystalline alane is composed completely of the α phase or a combination that includes α-alane.

The alane can be made by creating alane diethyl etherate using one or more acids including hydrochloric acid and/or methanesulfonic acid in an ether such as diethyl ether. A solution or a suspension of metal tetrahydroaluminate in ether is reacted with up to a stoichiometric amount of the one or more acids, as shown in equation (1) below. After filtration of the precipitated metal salts, a clear solution of alane-etherate is produced. This solution is stable for several days at less than room temperature (e.g., 3° C.) and in the absence of light. When sodium tetrahydroaluminate is used, it is preferred to include up to a stoichiometric amount of a solubilizing agent such as LiCl (X=Cl), as shown in equation (2).

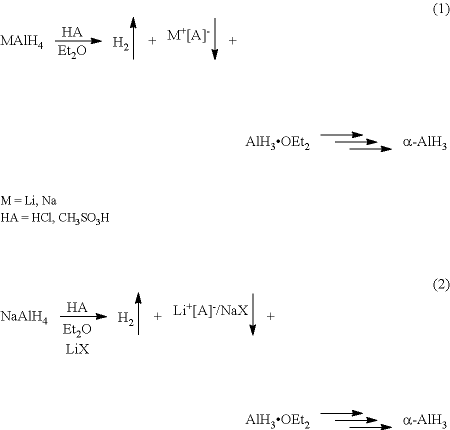

The solvent can be removed from the alane-etherate complex by various methods or combinations of methods, including distillation at ambinent or reduced pressure, heating at ambient or reduced pressure, or preferably a spray desolvation process such as electrospinning or electrospraying.

Brower, et. al. (1975) describes methods of creating non-solvated α-alane from an alane-ether complex. Brower also discloses that the reactions should be conducted in the absence of water, oxygen, and other reactive species.

Alternatively, as described in French Patent No. FR2245569 (1975), to desolvate and crystallize the α-polymorph, the diethyl ether may be removed from the crystallization solution, such as by distilling the diethyl ether. The distillation can be carried out between 50° and 85° C. At the bottom of this range, between 50° and 65° C., etherate intermediate is formed and is converted into α-alane. However, at the top of this range, between 65° and 85° C., etherate aluminum hydride does not appear and stable α-alane precipitates are formed almost immediately. By keeping the mixture in 8% to 10% of ether after the initial distillation, a final α-alane product may be obtained with superior features. Retention of the ether allows the rearrangement of alane during the conversion to the a form of alane as thermal decomposition of the crystal is reduced and the final product is crystalline. At an initial point in the distillation, spherical particles of the alane-ether complex may be present. These spherical particles may not necessarily be not α-alane crystals but are crystalline. However, as the diethyl ether is distilled, alane crystals may begin to form. The crystals formed initially may have a needlelike morphology, indicating formation of the α′ polymorph. After the α′ polymorph forms, additional diethyl ether may be added to the growing crystals. The additional diethyl ether may be removed by heating to a temperature ranging from approximately 88° C. to approximately 95° C., such as from approximately 88° C. to approximately 92° C. After removing the additional diethyl ether, the crystals may have a cubic or rhombohedral appearance, indicating formation of the a polymorph. Without being bound to a particular theory, it is believed that the α′ polymorph crystals may transform to crystals of the α polymorph upon heating and during distillation of the diethyl ether.

Alternatively, to remove the diethyl ether, the crystallization solution may be heated at ambient or reduced pressure, as described in U.S. Pat. No. 7,238,336 to Lund et al. For instance, if the diethyl ether is removed under vacuum, the crystallization solution may be heated at a temperature ranging from approximately 50° C. to approximately 60° C. However, if the diethyl ether is removed at ambient pressure, a temperature ranging from approximately 80° C. to approximately 100° C., such as from approximately 80° C. to approximately 97° C., may be used. A rate at which the diethyl ether is removed may affect the formation of the α-alane. If the diethyl ether is removed too quickly, the alane-ether complex may precipitate from the crystallization solution rather than forming the crystals of the α-alane. However, if the diethyl ether is removed too slowly, the crystallization process may be too long for practical and economical purposes. In one embodiment, the diethyl ether is removed by heating the crystallization solution to a temperature ranging from approximately 80° C. to approximately 95° C. Multiple heating cycles and subsequent dilutions with additional diethyl ether may be used to crystallize the α polymorph. The amount of diethyl ether in the crystallization solution may initially be reduced to less than approximately 10% by volume by heating the crystallization solution to a temperature ranging from approximately 80° C. to approximately 87° C., such as from approximately 82° C. to approximately 85° C. The remaining volume of the crystallization solution may then be heated until a precipitate is formed.

As yet another alternative, the solvent may be removed from alane by vacuum drying at temperatures between 30 and 90° C. This process may be enhanced when a desolvating species is present such as a complex metal hydride (LiAl₄, LiBH₄) or a metal halide (e.g., LiCl). See, e.g., A. N. Tskhai et al. Rus. J. Inorg. Chem. 37:877 (1992), and U.S. Pat. No. 3,801,657 to Scruggs. The desolvating species can be removed with a solvent that preferentially dissolves the desolvating species over the metal hydride. The desolvating species can also be removed with a solvent that preferentially dissolves the metal hydride over the desolvating species (as disclosed in U.S. Pat. No. 3,453,089 to Guidice). After removal the desolvating species can be recovered for further use.

Electrospraying employs electricity to disperse a liquid, usually resulting in a fine aerosol. High voltage is applied to a liquid supplied through an emitter (usually a glass or metallic capillary). Ideally the liquid reaching the emitter tip forms a Taylor cone, which emits a liquid jet through its apex. Varicose waves on the surface of the jet lead to the formation of small and highly charged liquid droplets, which are radially dispersed due to Coulomb repulsion. Electrospraying does not involve the use of polymers, so the jet emerging from the Taylor cone forms micro- or nano-scale droplets that dry rapidly, producing a coating of fine particles on the collector.

Similarly to the standard electrospraying, the application of high voltage to a polymer solution can result in the formation of a cone jet geometry. If the jet turns into very fine fibers instead of breaking into small droplets, the process is known as electrospinning. Electrospinning uses an electrical charge to draw micro- or nano-scale fibers from a liquid. Typically this involves pumping or dripping a polymer solution through a nozzle maintained at a high relative potential. The drops of solution become charged and electrostatic forces counteract the surface tension, at a critical point a jet of liquid is produced from the Taylor cone. As the jet travels through the atmosphere, the solvent evaporates, so when the jet reaches the collector plate it has formed dry polymer fibers. The electrospinning process can be further subdivided into single-phase or coaxial spinning; single-phase uses a single polymer solution in a relatively simple process, while the more complex co-axial spinning uses two solutions pumped through concentric needles, allowing finer control over material properties.

Both of these electro-hydrodynamic processes are controlled and affected by a wide variety parameters. The parameters include: solution parameters (such as viscosity/rheometry, surface tension, vapour pressure, conductivity, and dielectric constant); environmental parameters (such as temperature, and humidity/atmosphere); and process parameters (voltage, nozzle geometry, flow rates, and nozzle and plate separation).

There are a number of different spinning or spraying configurations that may be used, these include: 1) vertical (where the needle points downwards and material is collected on a flat plate); 2) horizontal (where the needle is horizontal and material is collected on a vertical plate); 3) spinning collector (where the material is collected on a spinning drum); and 4) multinozzle (where solution is pumped simultaneously through multiple nozzles housed in a discrete unit). These units may be joined to many other units to provide a scalable technology.

A stable spraying/spinning process is one where a Taylor cone forms consistently and shows little deviation during the process. The importance of this is: 1) to provide consistent fibers/beads/particles; and 2) to produce a scalable process.

Electrospraying can be used to reduce the amount of solvent in an alane-etherate solution. This is due to rapid evaporation occurring from the small particles produced during electrospraying. Electrospraying also removes more solvent than vacuum drying alone, and can potentially eliminate a vacuuming drying step in the process of alane production. Electrospraying also results in a more consistent particle size and morphology.

After substantially all of the diethyl ether has been removed, the α-alane crystals may be washed with an aqueous acidic solution to remove any impurities, such as at least one of aluminum (formed by pyrolysis), the α′ polymorph, lithium chloride, LiAlH₄, and other undesirable polymorphs. The acidic solution may include from approximately 0.1 percent by volume to approximately 25 percent by volume of an acid including HCl, methane sulfonic acid, or a combination thereof. In one embodiment, the acidic solution includes from approximately 10 percent by volume to approximately 12 percent by volume of HCl. The crystals of the α-alane may then be filtered to remove the acidic solution. The α-alane crystals may be rinsed with water to remove remaining trace amounts of the acidic solution, followed by rinses with acetone or isopropanol to remove the water. The α-alane crystals may then be dried.

While the above process describes the preferred reaction process, those skilled in the art will realize that other and further embodiments can be made without departing from the spirit of the inventive method of making α-alane. It should be noted that the operating temperatures and solvent may be altered and still result in the production of α-alane. In addition, the following aspects of the invention can be altered and extended without losing the advantages of the invention: the metal alanate used; stoichiometry; the acid used, order of addition, inclusion of a phase transfer catalyst; reaction temperature; and solvent used.

A crystallization additive may be added to help form the α-alane crystals during desolvation to isolate α-alane. The crystallization additive may promote growth of the α polymorph by providing a nucleation site for the α polymorph. The crystallization additive may also suppress formation of the undesirable polymorphs. It is also believed that early precipitation of the crystals may promote the growth of the α polymorph. Seed crystals of α-alane may be added during the crystallization to promote the growth of the α-alane. The seed crystals may subsequently be incorporated into the α-alane. The crystallization additive may be a complex hydride such as LiBH₄. The crystallization additive may also be an aprotic, electron-rich material. For instance, the crystallization additive may be an olefin, a polyolefin, an anisole, a polydimethyl siloxane, a tertiary amine, an aliphatic or aromatic ether, or mixtures thereof. The olefin may include, but is not limited to, squalene, cyclododecatriene, norbornylene, norbornadiene, a phenyl terminated polybutadiene, and mixtures thereof. The anisole may include, but is not limited to, 2,4-dimethyl anisole, 3,5-dimethyl anisole, 2,6-dimethyl anisole, and mixtures thereof. These compounds are commercially available from various manufacturers, such as from Sigma-Aldrich Co. (St. Louis, Mo.). The crystallization additive may also be polydimethyl siloxane. The crystallization additive may also be a combination of any of the additives.

The α-alane crystals may be stabilized by washing with an aqueous acidic solution to remove any impurities, such undesirable polymorphs or other impurities that exist as a result of the starting materials or the reaction process. The acidic solution may include from approximately 1 percent by volume to approximately 25 percent by volume of an acid, such as HCl, hydrofluoric acid, hydrobromic acid, phosphoric acid, perchloric acid, sulfuric acid, boric acid, or mixtures thereof. The acidic solution may include approximately 10 percent by volume to approximately 12 percent by volume of HCl. The crystals of the α-alane may then be filtered to remove the acidic solution. Other methods for stabilizing α-alane include reaction with silicol, or washing with pH-buffered solutions. The α-alane crystals may be rinsed with water to remove remaining trace amounts of the acidic solution, followed by rinses with acetone or isopropanol to remove the water. The α-alane crystals may then be dried.

Examples have been set forth below for the purpose of illustration and to describe the best mode of the invention at the present time. However, the scope of this invention is not to be in any way limited by the examples set forth herein.

### EXAMPLE 1

### Preparation of Alane-etherate from Lithium Aluminum Hydride

Lithium aluminum hydride (0.76 g, 20 mmol) is weighed into a 100 mL round-bottom flask containing a magnetic stirring bar in a glovebox under Ar atmosphere. The flask is sealed with a rubber septa and put under Ar on a shlenk line. Anhydrous diethyl ether (20 mL) is added. The septum was replaced quickly with a pressure-equalizing addition funnel that was being purged with Ar. A solution of 1M HCl in diethyl ether (16 mL, 16 mmol) is added dropwise over 30 minutes while stirring the reaction mixture in an ice-water bath. After addition of the acid is complete, the reaction mixture is allowed to warm to room temperature with stirring until hydrogen evolution ceased. The slurry is then filtered using a filter canula, and the insoluble material is washed once with fresh diethyl ether (10 mL). The combined filtrate containing alane-etherate in ether solution (ca. 0.35 M) can be used directly as a reducing agent in organic synthesis, as an initiator in polymerization reactions, or desolvated using methods reported in the literature to form α-alane suitable for use as a hydrogen storage fuel.

### EXAMPLE 2

### Preparation of Alane-Etherate using Sodium Aluminum Hydride

Sodium aluminum hydride (1.35 g, 25 mmol) and lithium chloride (0.848 g, 20 mmol) are combined in a 100 mL round-bottom flask containing a magnetic stirring bar in a glovebox under Ar atmosphere. The flask is sealed with a rubber septa and put under Ar on a Shlenk line. Anhydrous diethyl ether (20 mL) was added. The septum was replaced quickly with a condenser that is being purged with Ar. This slurry was stirred at reflux for three hours under Ar atmosphere, then cooled to 0° C. using an ice-water bath. The condenser is replaced quickly with a pressure-equalizing addition funnel that is being purged with Ar. A solution of 1M HCl in diethyl ether (20 mL, 20 mmol) is added to the addition funnel using a syringe, then added dropwise to the reaction mixture over 30 minutes while stirring in an ice-water bath. After addition of the acid is complete, the reaction mixture is allowed to warm to room temperature with stirring until hydrogen evolution ceased. The slurry was then filtered using a filter canula, and the insoluble material is washed once with fresh diethyl ether (10 mL). The combined filtrate containing alane-etherate in ether solution (ca. 0.4 M) can be used directly as a reducing agent in organic synthesis, as an initiator in polymerization reactions, or desolvated using methods reported in the literature to form α-alane suitable for use as a hydrogen storage fuel.

### EXAMPLE 3

### Electrospraying of Alane-Ether Solutions

An electrospraying apparatus as shown in FIG. 1 was assembled in an inert-atmosphere water-free glovebox. The apparatus 10 included a nozzle 12 through which an alane-etherate solution (alane in diethyl ether) was sprayed. A high voltage direct current power supply 14 was connected to the nozzle 12. The charged liquid spray included a straight jet 20 and a plume 22 of droplets, and material was collected on a collection plate 16. The process parameters, such as temperature, applied voltages, nozzle geometry, solution flow rate, the distance between nozzle and collection plate, and direction of spraying can be adjusted to control the amount of solvent removed and the particle size distribution and morphology of the alane produced, as well as to prevent or eliminate the release of hydrogen gas from the alane during the process.

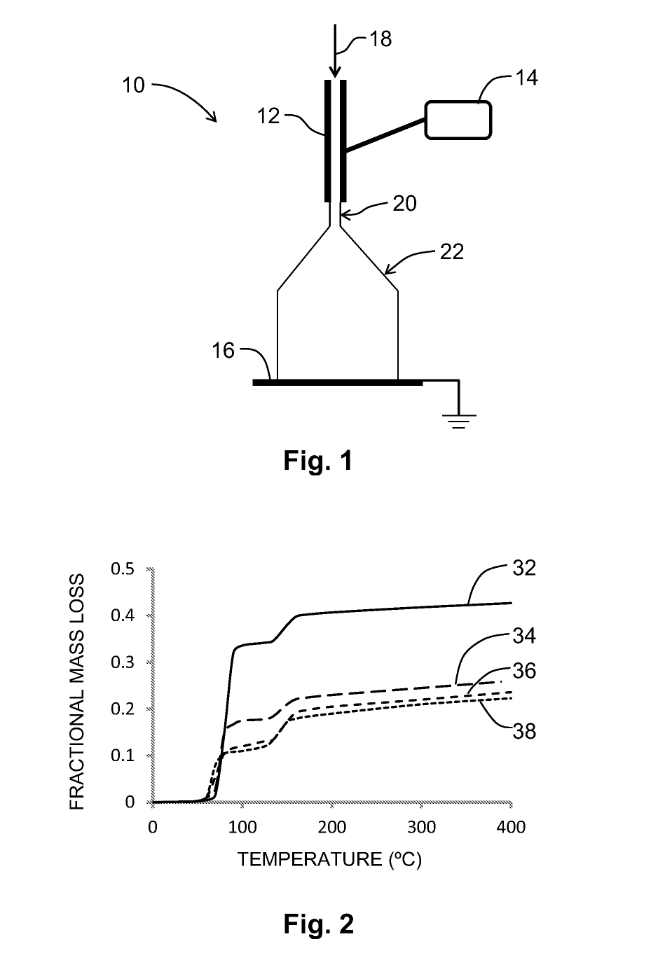

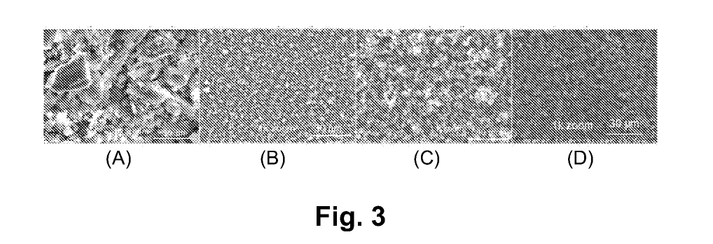

The electrosprayed alane can be annealed by controlling the ambient temperature of the spraying chamber, or by heating the collecting plate to the desired temperature. The TGA results for electrospraying of a 1 weight percent solution of alane in diethyl ether are shown in FIG. 2 and compared to the same solution dried using conventional methods. In FIG. 2, the annealing temperature in degrees Celsius is shown on the x-axis and the fractional mass loss on the y-axis. Line 32 shows conventionally dried solution, and lines 34, 36 and 38 show electrosprayed solution, with the spraying done vertically (as in FIG. 1) in line 34 and horizontally in each of lines 36 and 38. This data shows a significantly greater reduction in residual ether using the electrospray process (to about 83 weight percent) compared to conventional drying methods. The majority of the ether was removed at annealing temperatures from about 60° C. to 100° C. Hydrogen gas was evolved beginning at about 120° C.

NMR testing was done on material collected on the collection plate. The ²⁷Al-NMR results showed only the presence of residual LiAlH₄ and alane-etherate. TGA testing was performed on electrosprayed alane-etherate that was annealed at 65° C. The results showed pure hydrogen was released. The onset of dehydrogenation was lower compared to macrocrystalline alane (ca. 120° C. vs. 180° C.), presumably because of the small, uniform particle size of the electrosprayed alane. X-ray diffraction confirmed the formation of α-alane upon annealing at 65° C.

The SEM images in FIG. 3 show the difference in particle size and morphology between conventionally dried alane and electrosprayed alane-etherate. Image (A) shows alane-etherate that was vacuum dried and ground with a mortar and pestle, image (B) shows 0.5 weight percent alane in diethyl ether after electrospraying, image (C) shows 1.0 weight percent alane in diethyl ether after electrospraying, and image (D) shows 1.0 weight percent alane in diethyl ether after electrospraying and annealing at 65° C. Electrosprayed 1 weight percent alane solutions had a range of particle sizes from 1 μm to 500 nm, while electrosprayed 0.5 weight percent alane solutions had a particle size in the range of 300 nm to 100 nm. Thus, the solution concentration affected particle size, with the more dilute alane solution producing smaller particles. The uniformity of the particle size (fine particle size with consistent morphology) was maintained after annealing the electrosprayed alane particles at 65° C. In comparison, the vacuum dried sample, even after grinding, showed a very inconsistent morphology.

This example demonstrates that electrospraying improves the process of alane production, by making it easier to remove the solvent, eliminating the need for a vacuum drying stage, and consistently producing the correct phase with a beneficial morphology.

The above description is considered that of the preferred embodiments only. Modifications of the invention will occur to those skilled in the art and to those who make or use the invention. Therefore, it is understood that the embodiments described above are merely for illustrative purposes and not intended to limit the scope of the invention, which is defined by the following claims as interpreted according to the principles of patent law, including the Doctrine of Equivalents.

1. A method of producing solid α-alane comprising:
(a) reacting one or more acids, selected from hydrochloric acid and methanesulfonic acid, with one or more metal tetrahydroaluminates in a solvent comprising an ether to form an alane-ether mixture;
(b) removing the solvent from the alane-ether mixture by spray desolvation; and
(c) collecting the solid α-alane.

2. The method of claim 1, wherein the one or more acids consist of one or a combination of hydrochloric acid and methane sulfonic acid.

3. The method of claim 2, wherein the one or more acids consist of at least one of hydrochloric acid and methanesulfonic acid.

4. (canceled)

5. The method of claim 1, wherein the one or more metal tetrahydroaluminates comprise LiAlH₄.

6. The method of claim 1, wherein the one or more metal tetrahydroaluminates comprise NaAlH₄.

7. The method of claim 1, wherein the solvent comprises diethyl ether.

8. The method of claim 1 further comprising:
heating the solid α-alane at a temperature in a range of from greater than 60° C. to less than 120° C.

9. (canceled)

10. The method of claim 1, wherein the spray desolvation comprises electrospinning.

11. The method of claim 1, wherein the spray desolvation comprises electrospraying.

12. (canceled)

13. The method of claim 8, wherein the temperature is at least 65° C.

14. The method of claim 13, wherein the temperature is no greater than 100° C.

15. The method of claim 1, wherein desolvating the alane-ethereate complex comprises collecting electrosprayed material and annealing the collected electrosprayed material at a temperature of from 65° C. to 100° C. to form the α-alane.

16. A composition prepared by the method of claim 1, wherein the α-alane has a uniform particle size in a range of from 100 nm to 1000 nm.

17. A composition prepared by the method of claim 16, wherein the α-alane has a uniform particle size in a range of from 100 nm to 300 nm.

18. A composition prepared by the method of claim 16, wherein the α-alane has a uniform particle size in a range of from 500 nm to 1000 nm.
